(19) United States
(12) Patent Application Publication
(10) Pub. No.: US 2022/0100726 A1
(43) Pub. Date: Mar. 31, 2022

(54) REAL TIME DATA AGGREGATION AND ANALYSIS

(71) Applicant: MicroStrategy Incorporated, Tysons Corner, VA (US)

(72) Inventor: Baoxian Zhao, Annandale, VA (US)

(73) Assignee: MicroStrategy Incorporated

(21) Appl. No.: 17/361,757

(22) Filed: Jun. 29, 2021

Related U.S. Application Data
(60) Provisional application No. 63/083,271, filed on Sep. 25, 2020.

(51) Int. Cl. G06F 16/22; G06F 16/2455; G06N 20/00

(52) U.S. Cl. CPC G06F 16/2272; G06N 20/00; G06F 16/2455

(57) ABSTRACT

Disclosed are methods, systems, and computer-readable medium for real time data aggregation and analytics. For instance, the method may include receiving indexed streaming data from a plurality of sources, receiving historical data form the plurality of sources, aggregating the indexed streaming data and the historical data in real time to generate aggregated data, generating a machine learning model based on the historical data and providing the machine learning model to the real-time cube, providing the aggregated data to a real-time cube based on a query for the aggregated data, extracting updated data from the aggregated data and, providing the extracted updated data for visualization.

### CROSS-REFERENCE TO RELATED APPLICATION

This application claims benefit to U.S. Provisional Patent Application No. 63/083,271, filed on Sep. 25, 2020, the entire contents of which are incorporated herein by reference.

### TECHNICAL FIELD

Various embodiments of the present disclosure relate generally to methods and systems for real time data aggregation and, more particularly, to methods and systems for real time data aggregation for corresponding real time analytics.

### BACKGROUND

Entities of all sizes are generating and utilizing ever greater amounts of data. This data are processed and used in making decisions in business, government, healthcare, and other settings. In many cases, datasets are not in the appropriate form to be interpreted in real time and significant operations may be needed to prepare datasets for use in real time. Traditional techniques imitate real time data aggregation through the use of conjectures based on a series of past events and recent scans, without providing actual real time data aggregation and analysis. Such techniques often aren't meeting current needs due to, for example, the lag present in available information due to the lack of real time aggregation and analytics.

The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems, methods, and computer-readable medium are disclosed for real time data aggregation and analytics. For instance, a method may include: receiving indexed streaming data from a plurality of sources, receiving historical data form the plurality of sources, aggregating the indexed streaming data and the historical data in real time to generate aggregated data, generating a machine learning model based on the historical data and providing the machine learning model to the real-time cube, providing the aggregated data to a real-time cube based on a query for the aggregated data, extracting updated data from the aggregated data and, providing the extracted updated data for visualization.

The query for the aggregated data may be based on the machine learning model. The machine learning model may provide one or more triggers based on the historical data, wherein the one or more triggers may be applied by a visualization component that displays the extracted updated data.

Furthermore, a system may include at least one memory storing instructions; and at least one processor executing the instructions to perform operations. The system may further include a data aggregator, a real-time cube, the data aggregator, and a machine learning component. The data aggregator may be configured to, receive indexed streaming data from a plurality of clients, receive historical data from the plurality of clients, aggregate the indexed streaming data and the historical data in real-time to generate aggregated data, and provide the aggregated data to the real-time cube based on a query for the aggregated data. The machine learning component may be configured to generate a machine learning model based on the historical data and provide the machine learning model to the real-time cube. The real-time cube may be configured to, query aggregated from the data aggregator, receive the queried aggregated data from the data aggregator, extract updated data from the queried aggregated data, and provide the extracted updated data.

The real-time cube may configured to query real-time data from the data aggregator based on one of a push request or a poll request, wherein the updated data may be a subset of the real-time data that is modified between a current query and a previous query.

The model generated by the machine learning component may output one or more query recommendations, wherein the one or more query recommendations may be based on the aggregated data being input into the model. Alternatively or in addition, the model generated by the machine learning component outputs one or more trigger thresholds based on the historical data, wherein the real-time cube may generate a trigger warning based on the real-time data meeting the one or more trigger thresholds. The real-time cube may passively receive the real-time data from the data aggregator.

The system may further comprise a data broker configured to index streaming data. The data broker may provide the indexed streaming data to the data aggregator. The data broker may receive streaming data from a plurality of clients. The data broker may include a cluster of data brokers.

The system may further comprise a historical database configured to receive relational data, receive streaming data form a data processor, and provide the historical data to the data aggregator and the machine learning component.

Moreover, a non-transitory computer-readable medium may store instructions that, when executed by a processor, cause the processor to perform operations. The operations may include: receiving indexed streaming data from a plurality of sources, receiving historical data form the plurality of sources, aggregating the indexed streaming data and the historical data in real time to generate aggregated data, generating a machine learning model based on the historical data and providing the machine learning model to the real-time cube, providing the aggregated data to a real-time cube based on a query for the aggregated data, extracting updated data from the aggregated data and, providing the extracted updated data for visualization. The query for the aggregated data may be based on the machine learning model and the machine learning model may provide one or more triggers based on the historical data.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A depicts an exemplary block streaming data transmission from clients to data brokers, according to one or more embodiments.

FIG. 1B depicts an exemplary diagram of a data broker, according to one or more embodiments.

FIG. 2 depicts an exemplary block diagram of a system for real-time data aggregation and analytics, according to one or more embodiments.

FIG. 3 depicts a flowchart for real time data aggregation and analytics, according to one or more embodiments.

FIG. 4 depicts an example system that may execute techniques presented herein.

### DETAILED DESCRIPTION OF EMBODIMENTS

Various embodiments of the present disclosure relate generally to methods and systems for real-time data aggregation and analysis. Real-time data aggregation and analytics improves the way business intelligence (BI) can use data to predict outcomes, make adjustments, and formulate contingency plans without delay. Systems operating in real time can deliver insights on present conditions rather than putting together conjectures based on a series of past events and scans. Real-time data aggregation and analytics in BI is implemented by processing streaming data as it becomes available such that consumable insights are immediately provided without exceeding a time period allocated for decision-making and/or an analytical system triggers an action or a notification. The response times for real-time data aggregation and analytics can vary from nearly instantaneous to a few seconds (e.g., under 45 seconds).

In some implementations (e.g., monitoring a trains' brakes temperature, air conditioning temperature, geographic (GEO) localization, etc.), real-time data may be required to provide responses to new information within seconds. In other implementations (e.g., on-line store monitor system, mail delivery, etc.), data updates can be separated by minutes between updates. Accordingly, based on response time-frames, real-time data aggregation and analysis can be divided into two categories: a second based response time and a minute based response time.

Implementations provided herein allow faster access (e.g., a second based response time) to information as a result of the real-time data aggregation and analytics. Generally, the less time a system tool that relies on data waits to access the data, between the time that the data are generated and the time that it is made available for use, the faster the entity can use insights associated with the data in order to make changes and/or decisions.

Implementations of the disclosed subject matter are directed to methods and systems for real-time data aggregation and analysis on a multi-dimensional dataset by using a data aggregator that receives indexed data from a data broker, and a machine learning component for generating models based on historical data received from a historical database. A plurality of streams may provide real-time data to a data broker. The data broker may be a single data broker or a cluster of data brokers. It will be understood that, as applied herein, a “data broker” may reference a cluster of data brokers. The data broker may index the real-time data received from the plurality of streams and may transmit the indexed streaming data to a data aggregator.

Additionally, the data broker may provide non-indexed or indexed streaming data to a data processor and the data processor may store the non-indexed or indexed streaming data in a historical database. The historical database may also receive relational data and may provide the historical data and/or relational data to the data aggregator and a machine learning component.

The data aggregator may aggregate the indexed streaming data (e.g., from a plurality of sources) and the historical data and provide the aggregated data to a real-time cube. Additionally, the machine learning component may analyze the historical data to train a model to be used by the real-time cube. The model may be trained to output one or more query recommendations and/or the model may be trained to output one or more trigger thresholds based on the historical data. A trigger warning may be generated based on the trigger thresholds and may be provided via a component such as the visualization component.

The real-time cube may query the data aggregator for real-time aggregated data based on a model generated by the machine learning component. The real-time cube may receive the queried aggregated data and may extract updated data from the queried aggregated data. The updated data may refer to data that has changed since a previous query, such that only data that has changed is used by the real-time cube. By identifying the updated data (i.e., data that has changed since a previous query) system performance may significantly increase due to the reduced amount of data used for subsequent analysis. The real-time cube may use one or more application programming interfaces (APIs) to apply push and/or poll queries from the data aggregator.

In this manner, the methods and systems of the present disclosure may reduce processing time and memory usage, as discussed herein. While this disclosure describes the systems and methods with reference to real time data analytics using a data broker, data aggregator, data processor, historical database, machine learning component, and real-time cube, it should be appreciated that the present systems and methods may be applicable to real-time data aggregation and analytics in general.

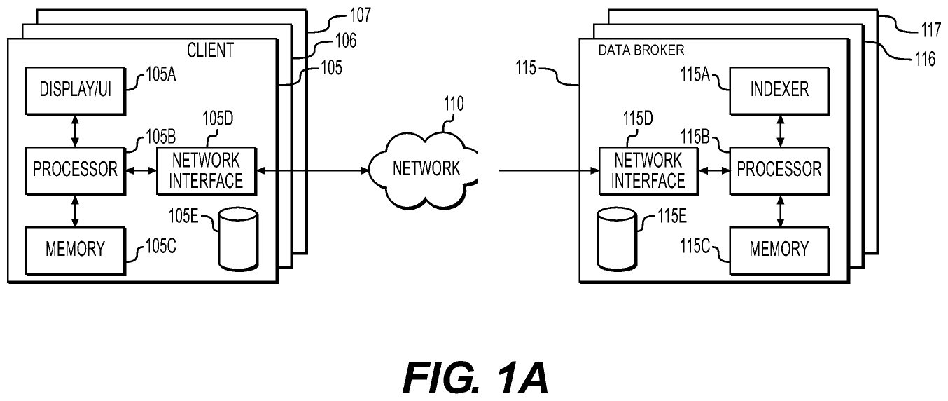

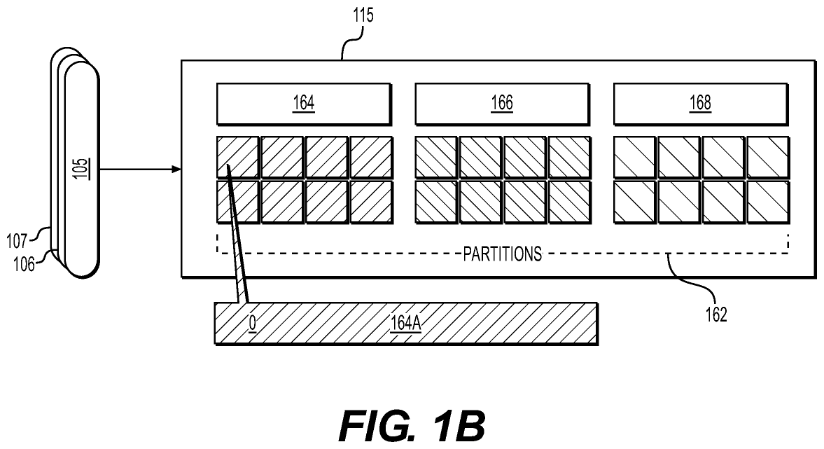

FIG. 1A depicts an exemplary block diagram of a system for receiving streaming data from a client (e.g., client 105, 106, 107, etc.) at a data broker (e.g. data broker 115, 117, and 117), according to one or more embodiments. The system 100 may include at least one client 105, a network 110, and/or at least one data broker 115. While the data broker 115 may interact with the client 105, it will be understood that the data broker 115 may interact with a plurality of clients such as client 106 and client 107, or that the client 105 and the data broker 115 may be hosted on a same device or same cloud platform. Additionally, a data broker may comprise a cluster of data brokers such as data broker 116 and data broker 117.

Each of the data brokers in a cluster of data brokers (e.g., data brokers 115, 116, and 117) may receive streaming data via one or more clients (e.g., clients 105, 106, and 107). Generally, while the functionality carried out by the data broker 115 and/or the client 105 are discussed herein separately, in practice these features may be executed on more or fewer devices and each data broker 115 may receive streaming data from a plurality of clients (e.g., clients 105, 106, and 107). As an example, a data broker 115, which may be a cluster of data brokers, may receive streaming data, via network 110, from a mobile applications, web applications, user data centers, financial transaction components, audit logs, service key performance indicators (KPIs), service logs, databases, message-oriented middleware, shopping cart data, pricing data, and or any other streaming source that generates data including real-time data. For simplicity, the disclosure provided here below refers to a single client 105 and a single data broker 115. However, it will be understood that client 105 may refer to a plurality of clients and data broker 115 may refer to a plurality of data brokers.

The client 105 and the data broker 115 may be connected via the network 110, using one or more standard communication protocols. The network 110 may be one or a combination of a wide area network (e.g., the internet), a local network, or other network. The client 105 and the data broker 115 may transmit and receive messages from each other across the network 110. According to an implementation, the network 110 may be a wired component that facilitates communication between the client 105 and the data broker 115.

The client 105 may include a display/user interface (UI) 105A, a processor 105B, a memory 105C, a network interface 105D, and/or a database 105E. The client 105 may be a computer, a cell phone, a tablet, a medical device, a sensor, etc. The client 105 may execute, by the processor 105B, an operating system (O/S) and at least one application (each stored in memory 105C). The application may be desktop program, a browser program, or a mobile application program (which may also be a browser program in a mobile O/S), an applicant specific program, or the like. The application may manage the database 105E to transmit streaming data to network 110. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 110. The processor 1058, while executing the application, may generate data and/or receive user inputs from the display/UI 105A and/or receive/transmit messages to the data broker 115, and may further perform one or more operations prior to providing an output to the network 110.

The application, executed by the processor 1058 of the client 105, may generate one or many points of data that can be applied via an overall system, such as for an analytics platform. As an example, the client 105 may be a medical device that receives multiple health attributes of a patient. The client 105 may be connected to a thermometer and a body surface electrode that is connected to a patient's chest via a patch. The client may receive a temperature signal and a heartbeat signal and the processor 105B may convert the received signals into a streaming data output that includes the values associated with the temperature signal and heartbeat signal as well as patient specific data (e.g., patient demographic data, patient health status, patient history, etc.). The streaming data output may transmitted via the network 110. Similarly, hundreds of other clients may receive temperature signals and heartbeat signals for hundreds of respective patients, and may convert the received signals into streaming data outputs to be provided to one or more data brokers (e.g., data broker 115).

The data broker 115 may include an indexer 115A, a processor 1158, a memory 115C, a network interface 115D, and/or database 115E. The data broker 115 may be a computer, system of computers (e.g., rack server(s)), and/or or a cloud service computer system. The data broker 115 may execute, by the processor 115B, an operating system (O/S) and at least one instance of a servlet program (each stored in memory 115C). The data broker 115 may store or have access to database 115E (e.g., hosted on a third party server or in memory 115C). The indexer 115A may be a part of the processor 1158 or may be a standalone component that interacts with the processor 1158. The indexer 115A may receive the streaming data generated by client 105 and may partition the streaming data based on one or more topics. The partitioned streaming data may be stored in memory 115C. The network interface 115D may be a TCP/IP network interface for, e.g., Ethernet or wireless communications with the network 110.

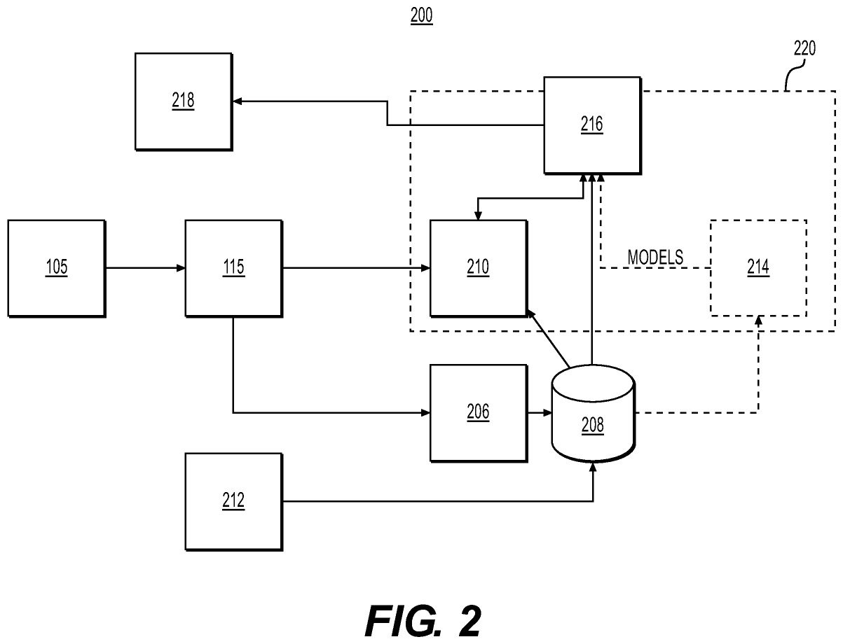

The data broker 115 may be a “publish-subscribe” based durable messaging system exchanging data between processes, applications, and servers (e.g., client 105 and data aggregator 210 of FIG. 2, as further disclosed herein). The data broker 115 may be implemented as a software, hardware, or firmware and is configured such that topics (e.g., categories) can be defined (e.g., via indexer 115A), and one or more data broker applications can add, process, and/or reprocess records via processor 1158.

The one or more data broker applications may be imbedded applications or may be third party applications in communication with the data broker 115. The one or more data broker applications may receive streaming data from the client 105 and may index the streaming data for storage with a topic. As disclosed herein, the streaming data may include any kind of information and, for example, may be the result of an event, may provide information, or may trigger an event. According to an implementation, the one or more data broker applications may process or re-process indexed streaming data from a topic. The indexed streaming data may be stored at the data broker 115 until a specified retention or transfer has occurs or when a given time period has expired.

The indexed streaming data may include byte arrays that can store any object in any applicable format. An indexed streaming data may be one or more attributes including a key, a value, a timestamp, and headers. The value may include the data generated by the client 105 and may be, for example, JSON or plain text. A topic may be a category or feed name to which the indexed streaming data are stored and published. The indexer 115A may write the indexed streaming data to one or more topics and consumer applications read from topics, as further discussed herein with reference to FIG. 1B.

According to an implementation, each topic (e.g., topics 164, 166, and 168 of FIG. 1B) may be divided into one or more partitions (e.g., partition 164A), which may include the indexed streaming data in a sequence (e.g., an unchangeable sequence). Each indexed streaming data in a partition may be assigned and identified by its unique offset. A topic may also have multiple partition logs which enable multiple consumers (e.g., data aggregator 210 and data processor 206 of FIG. 2, as further disclosed herein) to read from a given topic in parallel. The partitions may allow topics to be parallelized by splitting the data into a particular topic across multiple data brokers 115. At data broker 115, replication may implemented at the partition level. A redundant unit of a topic partition may be a replica and each partition may have one or more replicas such that partitions may include messages that are replicated over a few data brokers (e.g., data brokers 115, 116, and 117 of FIG. 1A) in a data broker cluster.

Each partition (i.e., replica) may have one server acting as a leader and the rest acting as followers. The leader replica may handle all read-write requests for the specific partition and the followers may replicate the leader. If the lead server fails, one of the follower servers may become the leader. The order of the leadership chain may be pre-determined, randomly determined, or may be determined based on one or more factors such as accessibility, failure cause, or the like. To clarify, a first data broker may be a leader of a first partition and a follower of a second partition whereas a second data broker may be a leader of a second partition and a follower of the first partition.

Upon receipt of streaming data from client 105 at data broker 115 (e.g., via network interface 115D), the streaming data may be indexed by indexer 115A and published to its designated data broker leader. The data broker leader may append the record to its commit log and increment its record offset. The indexed streaming data may be provided to consumer after it has been committed and each additional indexed streaming data that is received will be stacked on the cluster.

The indexer 115A may be part of one or more data brokers (e.g., data brokers 115, 116, 117, etc.) such that there are multiple version of indexer 115A or may be a standalone component that associates with each data broker. The indexer 115A may determine which partition of a given topic that received streaming data should be indexed to. According to an implementation, the indexer 115A may attach a key to the given streaming data, the streaming data indicating which partition that the given streaming data should be indexed based on. All streaming data with the same key may be indexed to the same partition. Before a client 105 provides streaming data to a data broker 115, the client 105 may request metadata related to the data broker 115, or a cluster of data brokers. The metadata may include information regarding which data broker 115 is the leader for each respective partition and the client 105 may provide the streaming data to a partition leader associated with the streaming data based on the key associated the applicable partition.

FIG. 1B is an example diagram of the data broker 115 in accordance with an implementation of the disclosed subject matter. The data broker 115 may include a number of partitions 162 based on topics 164, 166, and 168. The partitions may be occupied by indexed streaming data received from clients 105, 106, and 107. Although a single data broker 115 is shown, it will be understood that a cluster of multiple data brokers may be represented by the single data broker 115. In the example shown in FIG. 1B, the data broker 115 includes three topics 164, 166, and 168 and each topic has eight partitions 162.

The client 105 may transmit a first streaming data to be indexed at a given topic 164 and partition 164A. In this example, since the partition 164A is empty, the first streaming data may be indexed in topic 164 with an offset 0. A subsequent streaming data may be indexed at offset 1 if stored at topic 164 or at an offset 0 if stored in either topic 166 or 168. A consumer (e.g., data aggregator 210 or historical database 208 of FIG. 2, as further discussed herein) may specify the topic and offset based on the indexed streaming data being requested by the consumer.

The data broker 115 may retain indexed streaming data positions (e.g., type and offset) in a log such that one or more consumers can track the position of indexed streaming data and its corresponding offset in the log. As an example, a consumer may advance the offset in a linear manner as messages are retrieved. A consumer may also reset its request for indexed streaming data to an older offset, when reprocessing streaming data for any reason such as data loss or degradation.

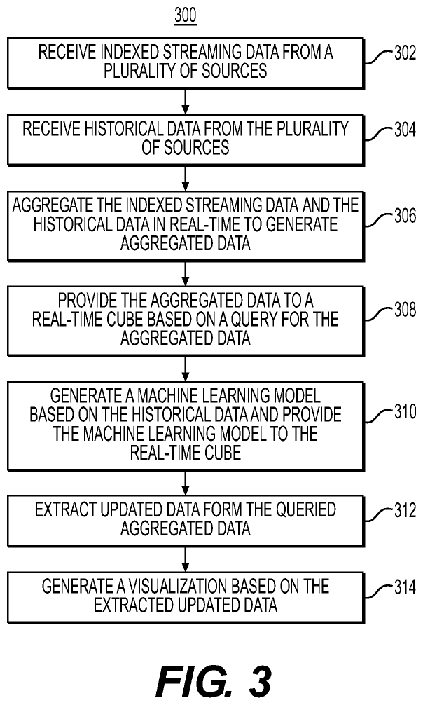

FIG. 2 depicts an exemplary block diagram of a system 200 for real-time data aggregation and analytics. Client 105 may provide streaming data to data broker 115, as disclosed herein. The data broker 115 may index the streaming data to generate indexed streaming data. The indexed streaming data may be indexed based on topics and/or partitions, as disclosed. FIG. 2 includes a client 105, a data broker 115, and a real-time analytics engine 220 including a data aggregator 210, a machine learning component 214, and a real-time cube 216. The real-time analytics engine 220 may provide out-of-the-box features or functionality (OOTB) for real-time data aggregation and analytics. A data processor 206, a historical database 208 configured to receive relational data 212, and a visualization component 218 are also depicted in FIG. 2. FIG. 3 depicts a flowchart 300 for real-time time data aggregation and analytics and includes steps that are disclosed herein in conjunction with the block diagram provided in FIG. 2.

At step 302 of FIG. 3, indexed streaming data may be received from a plurality of clients 105, 106, and 107. The indexed streaming data may be received at the data aggregator 210 from the data broker 115, and/or may be received at the data processor 206 from the data broker 115. The data aggregator 210 and/or the data processor 206 may query the indexed streaming data from the data broker 215 based on a topic (e.g., topic 164 of FIG. 1B) and partition (e.g., partition 164A of FIG. 1B).

At step 304, historical data may be received from a plurality of sources including client 105. The historical data may be stored in a historical database 208 that may receive streaming data originating from the client 105 such that the historical database 208 stores the streaming data for future use. The streaming data storage in historical database 208 may be past data collected at the historical database 208 over time. In contrast, the indexed streaming data received at the data aggregator 210 from the broker 115 may be real-time or approximately real-time data which may be overwritten or discarded after a threshold amount of time has elapsed or has been overwritten by a threshold amount of subsequent indexed streaming data.

The historical database may also receive relational data 212 which includes a collection of data with pre-defined relationships between them. This relational data 212 may be organized as a set of tables used to hold information about the objects to be represented in the historical database 208. The historical database 208 may provide the historical data, structured in accordance with the relational data 212, to the data aggregator 210, to the real-time cube 216, and/or to the machine learning component 214.

At step 306 of FIG. 3, the indexed streaming data and/or the historical data may be aggregated in real-time by the data aggregator 210. The data aggregator 210 may aggregate data that can be queried by the real-time cube 216. The data aggregator may be a real-time analytics database designed for fast “slice-and-dice” analytics (e.g., Online Analytical Processing “OLAP” queries) on large data sets. The data aggregator 210 may support use cases with real-time ingest, fast query performance, and/or high uptime. For example, the data aggregator 210 may support the graphical user interface (GUI) applications implemented by the visualization component 218, via the real-time cube 216. According to an example, the visualization component 218 may be configured with a rendering ability for up to or over ten-million records. As another example, the data aggregator 210 may support the data requirements implemented by the queries generated by the real-time cube 216, as a backend for highly-concurrent APIs that may need real-time aggregation (e.g., second based response time). The data aggregator 210 may support aggregation of event-oriented data, as provided by client 105 and aggregated with historical data received from the historical database 208. Although a single data aggregator 210 is shown in FIG. 2, it will be understood that the data aggregator 210 may be applied via a plurality of servers that may be located locally or remotely from each other.

The data aggregator 210 may use compressed bitmap indexes to create indexes that power fast filtering and real-time queries. The data aggregator 210 may first partition data by time and may also additionally partition data based on one or more other fields. Such multi-layered partitioning may lead to significant performance improvements for time-based queries. The data aggregator 210 may be deployed in clusters of tens to hundreds of servers and may process a query in parallel across the entire cluster, which offers ingest rates of millions of records/sec, retention of trillions of records, and query latencies of sub-second to a few seconds. Such factors may enable the data aggregator 210 to support real-time analytics.

The data aggregator 210 may be used to perform any applicable aggregation tasks including, but not limited to, clickstream analytics (e.g., web and mobile analytics), network telemetry analytics (e.g., network performance monitoring), server metrics storage, supply chain analytics (e.g., manufacturing metrics), application performance metrics, digital marketing/advertising analytics, business intelligence/OLAP, or the like. The data aggregator 210 may be used for processing real-time data aggregation, historical data, and real-time analytics and OLAP for BI. The data aggregator 210 may support both historical and real-time analytics which enables it to support the advanced usage of real-time analytics such as with AI usage. The data aggregator 210 may also support real-time aggregations, OLAP and BI requirements, time-based partitioning, indexes for quick filtering, scalable disturbed systems, massively parallel processing, query latency of 100 ms up to a few seconds, loud-native, and fault-tolerant architecture.

The data aggregator 210 may aggregate data indexed by the data broker 115 and originating from multiple clients 105, 106, and 107. As a specific example, a client 105 may provide warehouse inventory data, client 106 may provide sales data, and client 107 may provide warehouse efficiency data. The data broker 115 may index the various streaming data (e.g., the warehouse inventory data, the sales data, the warehouse efficiency data) based on the applicable topics. The data aggregator 210 may receive the separately partitioned data from the data broker 115 and may aggregate the various partitioned topics such that the aggregated data can be queried by the real-time analytics cube 216.

The data aggregator 210 may provide summarization at ingestion time. According to this implementation, the data aggregator 210 partially pre-aggregate the received indexed streaming data which results in both costs saving and performance boost when the aggregated data is queried by the real-time analytics cube 216.

The data aggregator 210 may apply a columnar storage format by using column-oriented storage. The column-oriented storage may enable the data aggregator 210 to load the exact columns needed for a particular query by the real-time analytics cube 216. The column-oriented storage may increase the speed for real-time analytics cube 216 queries that only ping a subset of the available columns. Additionally, each column using the column-oriented storage may be stored such that it is optimized for its particular data type, which further supports faster scans and aggregation.

The data aggregator 210 may apply a scalable distributed system. The data aggregator 210 may be deployed in clusters of tens to hundreds of servers, and may offer ingest rates of millions of records/sec, retention of trillions of records, and query latencies of sub-second to a few seconds. These factors may further enable the second based response time for real-time data aggregation and analytics.

The data aggregator 210 may apply massively parallel processing such that it process a given query in parallel across the entire cluster. The massively parallel processing may enable the data aggregator 210 to simultaneously fulfill a set of coordinated queries in parallel.

The data aggregator 210 may apply real-time or batch ingestion of streaming data from the data broker 115. The data aggregator 210 may ingest data in real-time such that the ingested indexed streaming data is immediately available for querying. The real-time ingestion may be applied to BI applications that require seconds based responses. Alternatively, for some applications that do not require seconds based responses, the data aggregator 210 maybe configured to ingest data in batches. The batches may be temporal based (e.g., every X amount of minutes) or may be volume based (e.g., when Y amount of streaming data is indexed and available).

The data aggregator 210 may be configured for self-healing and self-balancing. If a server, from a plurality of servers that host the data aggregator 210, fails, the system may be configured to automatically route around the failed server until it that can be replaced. The routing may be done in real-time to avoid any down-time for the data aggregator 210. A similar routing may occur during service patches or software updates such that the while a given server of the data aggregator 210 is being serviced or is updating, the system may automatically route around that server until the patch or update is completed. Additionally, the data aggregator 210 may be scaled out or scaled in by adding or removing servers such that the data aggregator 210 automatically rebalances itself, without exhibiting downtime.

The data aggregator 210 may be implemented via a cloud-native and fault-tolerant architecture to prevent data loss. Indexed streaming data received at the data aggregator 210 may be stored in deep storage (e.g., cloud storage, Hadoop Distributed File System (HDFS), or a shared file system). According to an implementation, the stored indexed streaming data may be recovered from such deep storage, even if each of a plurality of servers of the data aggregator 210 fail. Such replication may also enable query responses during limited server failures.

The data aggregator 210 may partition the indexed streaming data via a time based partitioning scheme. Additional partitioning may be implemented based on one or more other fields. Accordingly, time-based queries might only access the partitions that match the time range of the query which may result in significant performance improvements for time-based data and corresponding queries.

The data aggregator 210 may implement algorithms for approximate count-distinct, approximate ranking, and computation of approximate histograms and quantiles. These algorithms may offer bounded memory usage and provide substantially faster performance than exact computations. However, for implementations where accuracy is more important than speed, the data aggregator 210 may implement exact count-distinct and exact ranking.

At step 308 of FIG. 3, a portion of the data aggregated by the data aggregator 210 may be provided to the real-time cube 216. The portion of the aggregated data may be provided to the real-time cube 216 based on one or more queries generated by the real-time cube 216 and submitted to the data aggregator 210.

The real-time cube 216 may be a multi-dimensional cube that, for example, enables use of OLAP and/or BI services features. The real-time cube 216 may share sets of data among multiple reports to reduce repeat queries for the same or similar information.

The real-time cube 216 may be a cube that manages a set of data that can be shared as a single in-memory copy, among many different analytics components including visualization component 218. According to an implementation, the real-time cube 216 may contain the key tags (e.g., names) associated with data to be used for analysis and/or to build real-time visualizations. The real-time cube 216 may not contain any actual data but, rather, may pass data or analyzed data from the data aggregator 210 to a component such as the visualization component 218. The real-time cube 216 may return sets of data instead of returning data for a single report, such that the sets of data are stored in a memory. The real-time cube 216 collects sets of data for use by one or more components, such as the visualization component 218 and/or a component that uses OLAP services to report, analyze, and display data (not shown).

According to an implementation, the real-time cube 216 may not itself obtain objects that modify the display of data. The display of data may handled by the components that access the real-time cube 216. Accordingly, the one or more components may be implemented for consolidations and/or custom groups and the real-time cube 216 may include derived elements. Derived elements may combine the analysis features of consolidations and custom groups, while executing against the real-time cube 216, rather than a data warehouse or database.

According to an implementation, the real-time cube 216 may use the one or more APIs to apply push and/or poll queries from the data aggregator 210 and/or historical database 208. A push query may request data from the data aggregator 210 as soon as any new data is available at the data aggregator 210. The push query may enable the real-time cube 216 to passively receive data from the data aggregator 210. A poll query may be a periodic poll that occurs whether or not if the data aggregator 210 includes new data. The periodicity of the poll may be pre-determined, may be determined based on previously received data, or may be determined based on the machine learning model or other indication received from the machine learning component 214. The real-time cube 216 may apply a poll query for the historical database 208.

The real-time cube 216 may generate queries for the data aggregator 210 based on one or more of previous queries, queries based on data received from previous queries, queries provided by the machine learning component 214, pre-determined queries, or the like. The one or more previous queries or queries based on data received from previous queries may be based, at least in part, on a time duration between the previous query and a current query. The time duration may be determined based on the type of data being queried by the real-time cube 216. For example, the time duration for data related to a patient's heart rate may be once every five seconds while the heart rate is in a first (e.g., safe) range and may switch to every one second if the heart rate enters a second (e.g., cautionary) range.

At step 310 of FIG. 3, a model may be generated based on the historical data provided by the historical database 208. The model may be provided to the real-time cube 216 which may generate one or more queries based on the model or may determine one or more triggers based on the model. The model may be used by the real-time cube 216 to determine a query attribute such as a query frequency or what data to query. Additionally or alternatively, the model may receive data from the data aggregator 210 and use the data inputs to the model. As a result, the output from the model may be either a subsequent query recommendation for the real-time cube 216 and/or trigger thresholds based on the historical data. The trigger thresholds may be based on historically applicable data and may be used by the system for visualization (e.g., via the visualization component 218), for further analytics, and/or for a subsequent query (e.g., a time period for the subsequent query).

According to an implementation, the model may be based on one or more algorithms, such as a clustering algorithm, natural language processing algorithm, or the like. The one or more algorithms may be stored in a machine learning component 214 memory. As used herein, a “machine learning model” may include instructions, algorithms, data, representations of data, or the like that are usable, for example, to correlate data and/or identify relationships between aspects of data. A “machine learning model” further generally encompasses a model that may be trained, e.g., via a set of training data and one or more labels assigned to the set of training data, to generate an output for a particular input. Any suitable type of machine learning model may be used such as, for example, a neural network, a deep learning network, a genetic learning algorithm, or the like, or combinations thereof.

The model generated at step 310 by the machine learning component 214 may be trained based on the historical data provided by historical database 208. The historical database may provide historically streamed data from the client 105 as well as the relational data 212. The machine learning component 214 may receive the historical data and may train a model and/or update a previously trained model using the historical data. The type of model to be trained may be preselected or may be dynamically determined based on the machine learning component 214, may be dynamically determined based on a category of data, or may be dynamically determined based on the data itself.

At step 312, updated data may be extracted from the queried aggregated data provided at step 308. The updated data may be extracted by the real-time cube 216 or may be extracted before it is received at the real-time cube 216. The updated data may be data that has changed in comparison to the data provided during a previous query. Accordingly, the updated data may be a subset of the that is received based on a current query as only the subset of the data may be “new” when compared to a previous query. By extracting the updated data, the real-time cube 216 may minimize the amount of data that is provided to a component (e.g., the visualization component 218), instead of providing an entire dataset that includes both updated and non-updated data. Accordingly, providing the updated data instead of the entire dataset reduces the amount of resources required when applying the received data.

At step 314, the updated data may be used to generate a visualization. The visualization may be generated by visualization component 318 and may include a previously generated visualization that is updated based on the updated data. The previously generated visualization may be chronologically generated prior to being updated based on the updated data. The visualization may be any applicable visualization that can be displayed on a display such as a monitor, a laptop, a mobile device, a television, a holographic device, a wearable device, or the like. The visualization may also include one or more warnings based triggers. Although a visualization is generally disclosed herein, it will be understood that the one or more warnings may be auditory, haptic, or provided in any other applicable format. The one or more warnings based on triggers may be generated based on, for example, a machine learning model provided by the machine learning component 214 of the real-time analytics engine 220.

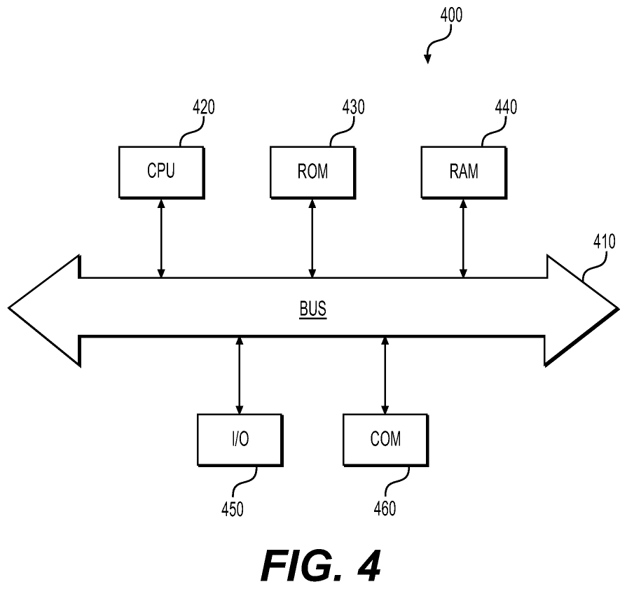

FIG. 4 shows an example system 400 that may execute techniques presented herein. FIG. 4 is a simplified functional block diagram of a computer that may be configured to execute techniques described herein, according to exemplary embodiments of the present disclosure. As an example, the system 400 may be part of one or more of the client 105, data broker 115, data processor 206, historical database 208, machine learning component 214, data aggregator 210, real-time cube 216, and/or visualization component 218. Specifically, the computer (or “platform” as it may not be a single physical computer infrastructure) may include a data communication interface 460 for packet data communication. The platform may also include a central processing unit (“CPU”) 420, in the form of one or more processors, for executing program instructions. The platform may include an internal communication bus 410, and the platform may also include a program storage and/or a data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system comprising at least one memory storing instructions and at least one processor executing the instructions to perform operations, the system further comprising:
a data aggregator;
a real-time cube;
the data aggregator configured to:
receive indexed streaming data from a plurality of clients;
receive historical data from the plurality of clients;
aggregate the indexed streaming data and the historical data in real-time to generate aggregated data; and
provide the aggregated data to the real-time cube based on a query for the aggregated data; and
a machine learning component configured to generate a machine learning model based on the historical data and provide the machine learning model to the real-time cube;
the real-time cube configured to:
query aggregated from the data aggregator;
receive the queried aggregated data from the data aggregator;
extract updated data from the queried aggregated data; and
provide the extracted updated data.

2. The system of claim 1, wherein the real-time cube is configured to query real-time data from the data aggregator based on at least one of a push request or a poll request.

3. The system of claim 2, wherein the updated data is a subset of the real-time data that is modified between a current query and a previous query.

4. The system of claim 1, wherein the machine learning model generated by the machine learning component outputs one or more query recommendations.

5. The system of claim 4, wherein the one or more query recommendations are based on the aggregated data being input into the machine learning model.

6. The system of claim 1, wherein the machine learning model generated by the machine learning component outputs one or more trigger thresholds based on the historical data.

7. The system of claim 6, wherein the real-time cube generates a trigger warning based on real-time data meeting the one or more trigger thresholds.

8. The system of claim 1, wherein the real-time cube passively receives the real-time data from the data aggregator.

9. The system of claim 1, further comprising a data broker configured to index streaming data.

10. The system of claim 9, wherein the data broker provides the indexed streaming data to the data aggregator.

11. The system of claim 10, wherein the data broker receives streaming data from a plurality of clients.

12. The system of claim 10, wherein the data broker comprises a cluster of data brokers.

13. The system of claim 1, further comprising a historical database configured to:
receive relational data;
receive streaming data form a data processor; and
provide the historical data to the data aggregator and the machine learning component.

14. A method for real-time data aggregation and analytics, the method comprising:
receiving indexed streaming data from a plurality of sources;
receiving historical data form the plurality of sources;
aggregating the indexed streaming data and the historical data in real time to generate aggregated data;
generating a machine learning model based on the historical data and providing the machine learning model to a real-time cube;
providing the aggregated data to the real-time cube based on a query for the aggregated data;
extracting updated data from the aggregated data; and
providing the extracted updated data for visualization.

15. The method of claim 14, wherein the query for the aggregated data is based on the machine learning model.

16. The method of claim 14, wherein the machine learning model provides one or more triggers based on the historical data.

17. The method of claim 16, wherein the one or more triggers are applied by a visualization component that displays the extracted updated data.

18. A non-transitory computer-readable medium storing instructions that, when executed by a processor, cause the processor to perform data aggregation and analytics operations, the operations comprising:
receiving indexed streaming data from a plurality of sources;
receiving historical data form the plurality of sources;
aggregating the indexed streaming data and the historical data in real time to generate aggregated data;
generating a machine learning model based on the historical data and providing the machine learning model to a real-time cube;
providing the aggregated data to the real-time cube based on a query for the aggregated data;
extracting updated data from the aggregated data; and
providing the extracted updated data for visualization.

19. The non-transitory computer-readable medium of claim 18, wherein the query for the aggregated data is based on the machine learning model.

20. The non-transitory computer-readable medium of claim 18, wherein the machine learning model provides one or more triggers based on the historical data.
